(19) United States
(12) Patent Application Publication
(10) Pub. No.: US 2026/0268388 A1
(43) Pub. Date: Sep. 10, 2026

(54) SHOPPING CART, METHOD, AND ITEM REGISTRATION DEVICE

(71) Applicant: Toshiba Tec Kabushiki Kaisha, Tokyo (JP)

(72) Inventor: Akira TAKAHASHI, Yokohama Kanagawa (JP)

(21) Appl. No.: 19/442,969

(22) Filed: Jan. 7, 2026

(30) Foreign Application Priority Data
Mar. 5, 2025 (JP) 2025-034338

(51) Int. Cl. G06Q 30/0601; G01G 19/12; G01G 19/414

(52) U.S. Cl. CPC G06Q 30/0633; G01G 19/12; G01G 19/4144

(57) ABSTRACT

A shopping cart includes frames on which containers for storing items can be placed, a weight sensor, a scanner, a display, an acceleration sensor, and a processor configured to acquire information of an item scanned by the scanner, register the scanned item, upon detection of weight increase by the weight sensor, determine whether the cart is in a moving state or in a state tilted from a horizontal state using the acceleration sensor, in response to determining that the shopping cart is in the moving state or in the state tilted, set a fluctuation range for an amount of weight increase of the containers corresponding to the scanned item, determine that an irregularity has occurred when the amount of weight increase measured by the weight sensor is outside the set range, and after determining that the irregularity has occurred, display alert information indicating that the irregularity has occurred.

### CROSS-REFERENCE TO RELATED APPLICATION(S)

This application is based upon and claims the benefit of priority from Japanese Patent Application No. 2025-034338, filed Mar. 5, 2025, the entire contents of which are incorporated herein by reference.

### FIELD

Embodiments described herein relate generally to a shopping cart, a method, and an item registration device.

### BACKGROUND

A shopping cart is known that provides an item registration function, allowing customers to register items they wish to purchase with the shopping cart used for shopping at a store. Such a shopping cart is equipped with a function to measure the weight of the registered items to determine whether they have been reliably placed in the cart.

In such a shopping cart, placing items while the cart is inclined or in motion can cause measurement errors in the item's weight. Furthermore, if the item's weight is inaccurate, it is impossible to correctly determine whether the scanned item has been placed in the shopping cart.

### SUMMARY OF THE INVENTION

Embodiments of the present disclosure provide a shopping cart, a method, and an item registration device capable of reliably determining whether a stored item is a scanned item even when the item is stored while the shopping cart is moving or inclined.

A shopping cart comprises: one or more frames on which one or more containers for storing one or more items can be placed; a weight sensor configured to measure a weight of the one or more containers placed on the one or more frames; a scanner configured to scan a symbol attached to an item and read item information from the symbol; a display attached to the one or more frames and configured to display a screen showing information regarding an item registered for purchase; an acceleration sensor; a memory that stores a program; and a processor configured to execute the program to: acquire identification information of an item scanned by the scanner, register the scanned item for purchase using the identification information, upon detection of weight increase of the one or more containers by the weight sensor, determine whether the shopping cart is in a moving state or in a state tilted from a horizontal state based on an output from the acceleration sensor, in response to determining that the shopping cart is in the moving state or in the state tilted from the horizontal state, set a fluctuation range for an amount of weight increase of the one or more containers corresponding to the scanned item, determine that an irregularity has occurred when the amount of weight increase of the one or more containers measured by the weight sensor is outside the set fluctuation range, and after determining that the irregularity has occurred, control the display to display alert information indicating that the irregularity has occurred.

### BRIEF DESCRIPTION OF THE DRAWINGS

FIG. 1 is a perspective view illustrating a shopping cart according to a first embodiment.

FIG. 2 is a hardware block diagram of the shopping cart according to the first embodiment.

FIG. 3 is a diagram illustrating an example of a data structure of an item master.

FIG. 4 is a diagram illustrating an example of a data structure of a weight master.

FIG. 5 is a functional block diagram of the shopping cart according to the first embodiment.

FIG. 6 is a flowchart of processing performed by the shopping cart according to the first embodiment.

FIG. 7 is a functional block diagram of a shopping cart according to a second embodiment.

FIG. 8 is a flowchart of processing performed by the shopping cart according to the second embodiment.

FIG. 9 is a functional block diagram of a shopping cart according to a third embodiment.

FIG. 10 is a flowchart of processing performed by the shopping cart according to the third embodiment.

### DETAILED DESCRIPTION

### First Embodiment

First, a shopping cart 10 according to a first embodiment will be described.

### Schematic Configuration of Shopping Cart

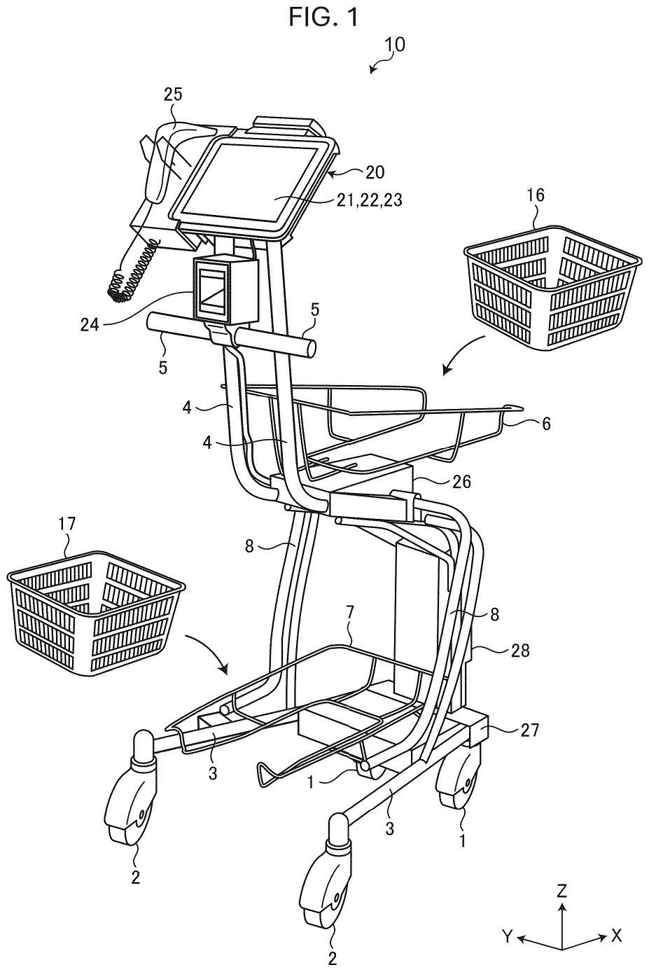

A schematic configuration of the shopping cart 10 will be described with reference to FIG. 1. FIG. 1 is a perspective view illustrating the shopping cart 10 according to the first embodiment.

The shopping cart 10 reads item information of an item that a customer wants to purchase while the customer walks in the store, and registers the item. The customer keeps shopping by putting the registered items in the shopping basket placed in the shopping cart 10. After the shopping is finished, the customer goes to a checkout device (not shown) and causes the checkout device to perform a settlement process related to the registered item. The shopping cart 10 itself may have a function for performing the settlement process. The shopping cart 10 is an example of an item registration device for a shopping cart in the present disclosure.

The shopping cart 10 includes a pair of bottom frames 3, each of which includes front wheels 1 and rear wheels 2. A pair of upper frames 4 extending upward are connected to the pair of bottom frames 3. The front wheels 1 and the rear wheels 2 are respectively mounted on casters which can freely rotate about a mounting shaft relative to the bottom frame 3. Therefore, the direction of travel of the shopping cart 10 can be changed to the left or right according to the force applied to the pair of handles 5 installed above the shopping cart 10. That is, the shopping cart 10 is capable of changing directions. The customer holds the pair of handles 5 and pushes the cart while walking to change the orientation of the shopping cart 10 to the left and right.

A charge controller 27 is mounted between the pair of bottom frames 3. The charge controller 27 includes a charging circuit (not shown), and charges the battery 28 by the charging circuit. Although detailed description is omitted, the charge controller 27 includes an input connector and an output connector, and charges the battery 28 with power supplied from a power supply device (not shown) in a state where a plurality of shopping carts 10 are nested together. The charge controller 27 also serves as a strength member for connecting the left and right bottom frames 3.

An upper frame 4 is attached to the front side (+X direction side) of the bottom frame 3, the upper frame 4 rising upward (+Z direction), then extending obliquely upward toward the front (−X direction), and then extending upward (+Z direction). The upper frame 4 holds the battery 28. The battery 28 is a rechargeable secondary battery that supplies current to various electronic devices included in the shopping cart 10. The battery 28 is, for example, a lithium ion battery, a nickel cadmium battery, a nickel hydrogen battery, a lead storage battery, or the like.

An upper basket support frame 6 is attached to the upper frame 4. A shopping basket 16 for accommodating items when a customer does shopping is placed on the upper basket support frame 6. The shopping basket 16 is an example of a container in the present disclosure.

A lower basket support frame 7 is attached to the upper side of the bottom frame 3. A shopping basket 17 for accommodating items when a customer does shopping is placed on the lower basket support frame 7. The shopping basket 17 is an example of a container in the present disclosure. The lower basket support frame 7 is attached to a pair of suspended frames 8 extending downward from the upper basket support frame 6.

A weight sensor 26 is installed immediately below the upper basket support frame 6 at a position where the upper frame 4 extends to the front side (-X direction). The weight sensor 26 measures the sum of the weight of the items accommodated in the shopping basket 16 placed on the upper basket support frame 6 and the weight of the items accommodated in the shopping basket 17 placed on the lower basket support frame 7. As described above, since the lower basket support frame 7 is connected to the upper basket support frame 6 by the pair of suspended frames 8, the total weight of the items accommodated in the shopping basket 16 and the items accommodated in the shopping basket 17 is detected by the weight sensor 26. The weight sensor 26 is a known sensor such as a strain gauge whose electric resistance changes according to expansion and contraction, for example.

A tablet device 20 and a hand scanner 25 are installed on the upper portions of the pair of upper frames 4. A fixed scanner 24 is installed at the center of the pair of handles 5. All of these electronic devices operate on power from the battery 28.

The tablet device 20 registers an item that the customer wants to purchase. The tablet device 20 includes a display 21, a touch panel 22, and an acceleration sensor 23. The tablet device 20 may further have a function of performing payment related to the registered item.

The display 21 displays various information related to item registration. The display 21 is, for example, a liquid crystal monitor or an organic EL monitor.

The touch panel 22 is disposed on the display 21 and detects operations on various buttons displayed on the display 21.

The acceleration sensor 23 detects whether the shopping cart 10 is in a moving state and whether the shopping cart 10 is in a state of being inclined from a horizontal state. The acceleration sensor 23 is implemented by using a known functional device such as a piezoelectric device that detects the amount of charge generated in accordance with applied vibration or a piezoelectric device whose electric resistance changes in accordance with applied pressure. The acceleration sensor 23 may be a combination of an acceleration sensor and a gyro sensor. The acceleration sensor 23 may be incorporated in the weight sensor 26. When the acceleration sensor 23 determines that the shopping cart 10 is in the moving state or is in a state of being inclined from the horizontal state, the shopping cart 10 sets a fluctuation range for the weight of the item accommodated in the shopping baskets 16 and 17 measured by the weight sensor 26.

The fixed scanner 24 reads a code symbol such as a barcode attached to an item to be sold, which is held over a scan window on the front surface. Identification information that uniquely identifies the item (for example, item code) is encoded in the code symbol. The fixed scanner 24 decodes the reading result of the code symbol to acquire the item code.

The hand scanner 25 reads the code symbol attached to the item and acquires the item code, similarly to the fixed scanner 24. In particular, the hand scanner 25 is used when reading a code symbol of an item, such as a heavy object or a large item, which is difficult to read by the fixed scanner 24.

### Hardware Configuration of Shopping Cart

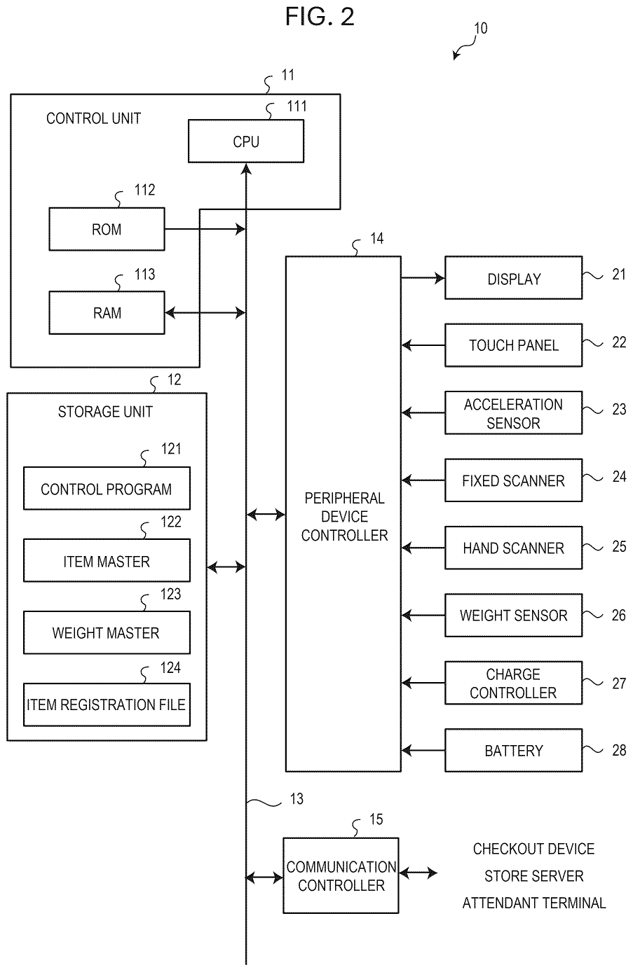

A hardware configuration of the shopping cart 10 will be described with reference to FIG. 2. FIG. 2 is a hardware block diagram of the shopping cart 10 according to the first embodiment.

The shopping cart 10 has a configuration in which a control unit 11, a storage unit 12, a peripheral device controller 14, and a communication controller 15 are connected to each other via an internal bus 13.

The control unit 11 controls the overall operation of the shopping cart 10. The control unit 11 includes a Central Processing Unit (CPU) 111, a Read Only Memory (ROM) 112, and a Random Access Memory (RAM) 113. The CPU 111 is connected to the ROM 112 and the RAM 113 via internal buses such as address buses and date buses. The CPU 111 loads various programs stored in the ROM 112 or the storage unit 12 into the RAM 113. The CPU 111 operates according to various programs loaded into the RAM 113, thereby controlling the operation of the shopping cart 10.

The storage unit 12 is a storage device such as a Hard Disk Drive (HDD) or a Solid State Drive (SSD). The storage unit 12 may be a nonvolatile memory such as a flash memory that retains stored information even when the power is turned off. The storage unit 12 stores a control program 121, an item master 122, a weight master 123, and an item registration file 124.

The control program 121 is a program that controls the overall operation of the shopping cart 10. The control program 121 may be provided in a state of being stored in the storage unit 12, or may be provided by being recorded in a computer-readable non-transitory recording medium such as a CD-ROM, a flexible disk (FD), a CD-R, or a DVD in a file of an installable format or an executable format. The control program 121 may be stored in a computer connected to a network and provided by being downloaded via the network. Further, the control program 121 may be provided or distributed via a network such as the Internet.

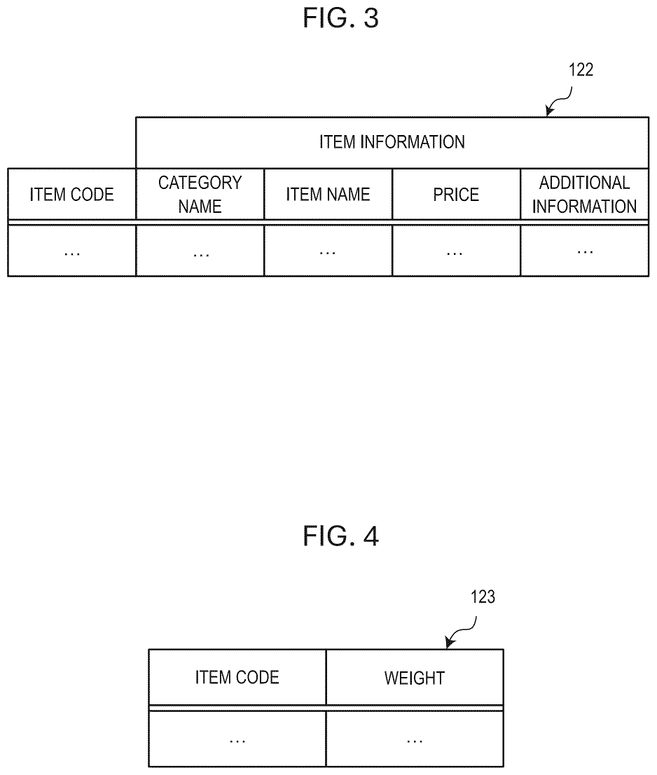

The item master 122 is a master file that stores item information such as the item name and price of the items to be sold. The item master 122 stores item information in association with identification information for uniquely identifying an item, for example, an item code. The data structure of the item master 122 will be described in detail later (see FIG. 3). Note that, since the content of the item master is updated as needed, the shopping cart 10 acquires the latest item master from, for example, a store server (not illustrated) via the communication controller 15, thereby always updating the content of the item master 122 to the latest state.

The weight master 123 is a master file that stores weight information of items to be sold. The weight master 123 stores the weight of the item in association with identification information for uniquely identifying the item, for example, an item code. The data structure of the weight master 123 will be described in detail later (see FIG. 4). Note that, since the content of the weight master is updated as needed, the shopping cart 10 acquires the latest weight master from, for example, a store server (not illustrated) via the communication controller 15, thereby always updating the content of the weight master 123 to the latest state.

The item registration file 124 is a file that stores registered item information (for example, item code, item name, quantity, unit price, and the like) and a total purchase amount in association with a transaction code that specifies one transaction.

The control unit 11 is connected to various peripheral devices such as a display 21, a touch panel 22, an acceleration sensor 23, a fixed scanner 24, a hand scanner 25, a weight sensor 26, a charge controller 27, and a battery 28 via a peripheral device controller 14. The outline of each peripheral device is as described above, and thus the description thereof will not be repeated.

The control unit 11 also exchanges various types of information with a checkout device, a store server, and an attendant terminal, which are not shown, via the communication controller 15.

For example, the control unit 11 obtains the latest item master and weight master from the store server. The control unit 11 outputs an item registration file to the store server for sales management of the store.

Additionally, the control unit 11 notifies the attendant terminal that the customer has committed fraud, such as placing unregistered items into shopping baskets 16 and 17.

The control unit 11 outputs the content of the item registration file 124 to the checkout device to perform settlement.

### Data Structure of Item Master

The data structure of the item master 122 will be described with reference to FIG. 3. FIG. 3 is a diagram illustrating an example of a data structure of an item master.

The item master 122 stores item information in association with an item ID (for example, an item code). The item information includes a category name, an item name, a price, and additional information.

The category name is the name of the category to which the item belongs.

The item name is the name of the item.

The price is the unit price of the item.

The additional information refers to other details related to the item's classification or price. For example, the additional information includes discount details such as time-limited offers or limited-time pricing, as well as tax rate information based on sales forms such as eating-in or take-out.

The information stored in the item master 122 is not limited to the information illustrated in FIG. 3.

### Data Structure of Weight Master

The data structure of the weight master 123 will be described with reference to FIG. 4. FIG. 4 is a diagram illustrating an example of a data structure of a weight master.

The weight master 123 stores the weight of the item in association with the item ID (for example, item code).

The item master 122 may further store the weight of the item and also serve as the weight master 123.

### Functional Configuration of Shopping Cart

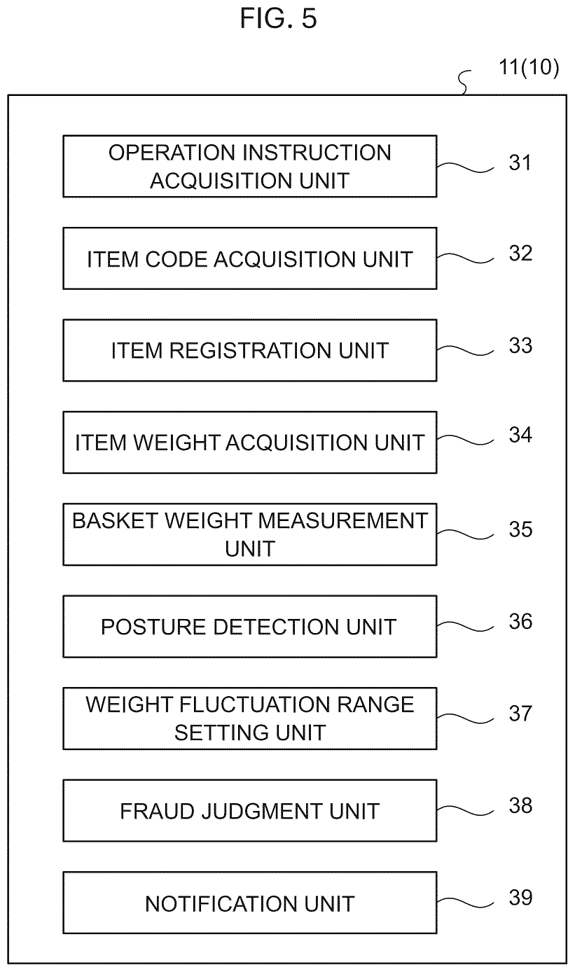

A functional configuration of the shopping cart 10 according to the first embodiment will be described with reference to FIG. 5. FIG. 5 is a functional block diagram of the shopping cart 10 according to the first embodiment.

The control unit 11 of the shopping cart 10 loads the control program 121 into the RAM 113 and executes the control program, thereby implementing an operation instruction acquisition unit 31, an item code acquisition unit 32, an item registration unit 33, an item weight acquisition unit 34, a basket weight measurement unit 35, a posture detection unit 36, a weight fluctuation range setting unit 37, a fraud judgment unit 38, and a notification unit 39 illustrated in FIG. 5 as functional units. Note that some or all of these functional parts may be implemented by dedicated hardware.

The operation instruction acquisition unit 31 acquires an instruction to start item registration from the customer. To be specific, the operation instruction acquisition unit 31 determines that the start of the item registration is instructed when it is detected that an item registration start button (not shown) displayed on the display 21 is pressed. The operation instruction acquisition unit 31 receives an instruction from the customer indicating that registration of all items is completed. To be specific, the operation instruction acquisition unit 31 determines that the registration of all the items is completed when it is detected that a checkout button (not shown) displayed on the display 21 is pressed.

The item code acquisition unit 32 acquires identification information (for example, an item code) of an item that the customer desires to purchase. To be specific, the item code acquisition unit 32 acquires the item code encoded in the code symbol read by the fixed scanner 24 or the hand scanner 25.

The item registration unit 33 registers the item having the item code acquired by the item code acquisition unit 32 in the item registration file 124.

The item weight acquisition unit 34 acquires the weight of the item having the item code acquired by the item code acquisition unit 32 from the weight master 123.

The basket weight measurement unit 35 measures the weight of the shopping baskets 16 and 17 that accommodate the item whose item code has been acquired.

The posture detection unit 36 may detect whether the shopping cart 10 is in a moving state or whether the shopping cart 10 is in a state of being inclined from a horizontal state. Specifically, the posture detection unit 36 may detect whether the shopping cart 10 is in the moving state or the shopping cart 10 is in a state of being inclined from the horizontal state based on the output of the acceleration sensor 23.

Since the shopping cart 10 of the present embodiment is used in a state where the customer is pushing it while walking, the items may be stored while the shopping cart 10 is moving or in a state where the shopping cart 10 is inclined from the horizontal state. In this way, when the item is stored in a state of being inclined from the horizontal state or during movement, the item moves inside the shopping baskets 16 and 17, and thus the load of the item applied to the weight sensor 26 is not uniform, and thus there is a possibility that the weight of the item to be measured may vary. Therefore, the posture detection unit 36 of the shopping cart 10 detects whether the shopping cart 10 is in a state where there is a possibility that the weight of the item to be measured may vary.

The weight fluctuation range setting unit 37 sets a fluctuation range of the amount of weight increase of the shopping baskets 16 and 17 according to the item having the item code acquired by the item code acquisition unit 32, on condition that the posture detection unit 36 detects that the shopping cart 10 is in the moving state or the inclined state when the basket weight measurement unit 35 determines that the weight of the shopping baskets 16 and 17 has increased. The weight fluctuation range setting unit 37 sets, for example, ±5% of the weight of the item as the fluctuation range. To be specific, in a case where the weight of the item is 300 g, the weight fluctuation range setting unit 37 sets the fluctuation range of the weight of the item to 285 to 315 g.

The fraud judgment unit 38 determines that a fraud in which an item different from the item whose item code has been read is placed in the shopping baskets 16 and 17 has been performed when the amount of weight increase of the shopping baskets 16 and 17 measured by the basket weight measurement unit 35 is out of the range of the fluctuation range of the amount of weight increase set by the weight fluctuation range setting unit 37. In addition, when the weight of the item registered by the item registration unit 33 is not equal to the amount of weight increase of the shopping baskets 16 and 17 measured by the basket weight measurement unit 35, the fraud judgment unit 38 determines that a fraud in which an item different from the item whose item code is read is placed in the shopping baskets 16 and 17 has been performed. That is, the fraud judgment unit 38 determines whether an irregularity has occurred during item registration.

When the fraud judgment unit 38 determines that the fraud has been performed, the notification unit 39 notifies the display 21 of the determination result and prompts the customer to rescan the item. In addition, the notification unit 39 may notify an attendant terminal (not illustrated) that the fraud has been performed together with the identification number for specifying the shopping cart 10.

### Flow of Processing Performed by Shopping Cart of First Embodiment

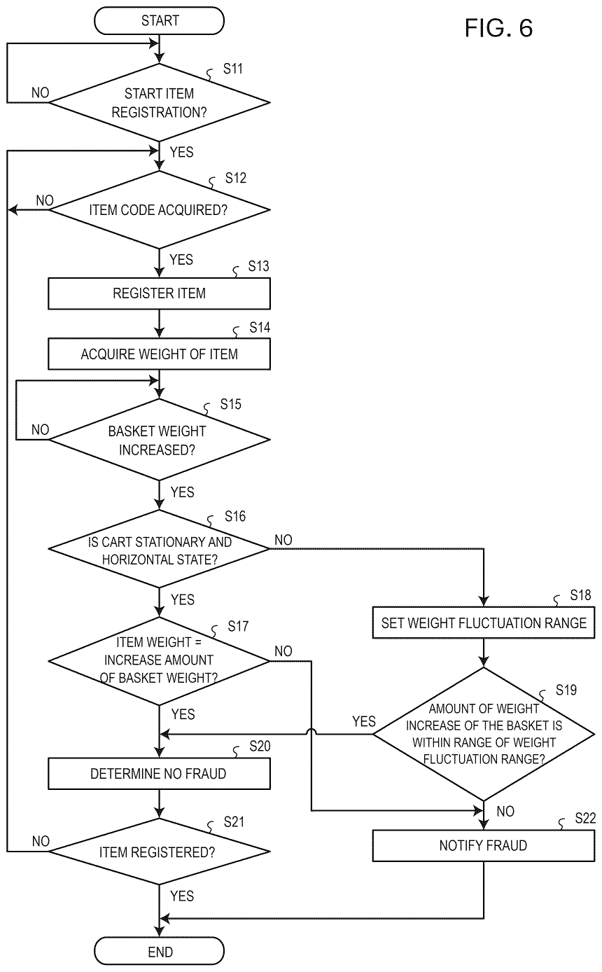

A flow of processing performed by the shopping cart 10 according to the first embodiment will be described with reference to FIG. 6. FIG. 6 is a flowchart of processing performed by the shopping cart 10 according to the first embodiment.

The operation instruction acquisition unit 31 determines whether the customer has started item registration (step S11). When it is determined that the customer has started item registration (step S11: Yes), the process proceeds to step S12. On the other hand, when it is not determined that the customer has started item registration (step S11: No), the determination of step S11 is repeated. Note that the operation instruction acquisition unit 31 determines that the start of item registration has been instructed when it is detected that an item registration start button (not shown) displayed on the display 21 has been pressed.

When it is determined in step S11 that the customer has started item registration, the item code acquisition unit 32 determines whether or not an item code has been acquired (step S12). When it is determined that the item code has been acquired (step S12: Yes), the process proceeds to step S13. On the other hand, when it is not determined that the item code has been acquired (step S12: No), the determination of step S12 is repeated.

When it is determined in step S12 that the item code has been acquired, the item registration unit 33 registers the item having the item code acquired by the item code acquisition unit 32 in the item registration file 124 (step S13).

The item weight acquisition unit 34 acquires the weight of the item registered by the item registration unit 33 from the weight master 123 (step S14).

The basket weight measurement unit 35 determines whether the weight of the shopping baskets 16 and 17 has increased (step S15). When it is determined that the weight of the shopping baskets 16 and 17 has increased (step S15: Yes), the process proceeds to step S16. On the other hand, when it is not determined that the weight of the shopping baskets 16 and 17 has increased (step S15: No), the determination of step S15 is repeated.

When it is determined in step S15 that the weight of the shopping baskets 16 and 17 has increased, the posture detection unit 36 determines whether the shopping cart 10 is in the stationary state and the horizontal state (step S16). When it is determined that the shopping cart 10 is in the stationary state and the horizontal state (step S16: Yes), the process proceeds to step S17. On the other hand, when it is not determined that the shopping cart 10 is in the stationary state and the horizontal state (step S16: No), the process proceeds to step S18.

When it is determined in step S16 that the shopping cart 10 is in the stationary state and the horizontal state, the fraud judgment unit 38 determines whether the weight of the item acquired in step S14 is equal to the amount of weight increase of the shopping baskets 16 and 17 measured in step S15 (step S17). When it is determined that the weight of the item acquired in step S14 is equal to the amount of weight increase of the shopping baskets 16 and 17 measured in step S15 (step S17: Yes), the process proceeds to step S20. On the other hand, when it is not determined that the weight of the item acquired in step S14 is equal to the amount of weight increase of the shopping baskets 16 and 17 measured in step S15 (step S17: No), the fraud judgment unit 38 determines that the fraud is being performed, and proceeds to step S22.

In step S17, when it is determined that the weight of the item acquired in step S14 is equal to the amount of weight increase of the shopping baskets 16 and 17 measured in step S15, the fraud judgment unit 38 determines that the fraud is not performed (step S20).

The operation instruction acquisition unit 31 determines whether registration of all items is completed (step S21). When it is determined that the registration of all the items is completed (step S21: Yes), the shopping cart 10 ends the process. On the other hand, when it is not determined that the registration of all the items is completed (step S21: No), the process returns to step S12.

The description returns to step S16. In step S16, when it is not determined that the shopping cart 10 is in the stationary state and the horizontal state, the weight fluctuation range setting unit 37 sets the fluctuation range of the amount of weight increase of the shopping baskets 16 and 17 according to the weight of the item acquired in step S14 (step S18).

The fraud judgment unit 38 determines whether the amount of weight increase of the shopping baskets 16 and 17 is within the range of the fluctuation range of the amount of weight increase set in step S18 (step S19). When it is determined that the amount of weight increase of the shopping baskets 16 and 17 is within the range of the fluctuation range of the amount of weight increase set in step S18 (step S19: Yes), the process proceeds to step S20. On the other hand, if it is not determined that the amount of weight increase of the shopping baskets 16 and 17 is within the range of the fluctuation range of the amount of weight increase set in step S18 (step S19: No), the process proceeds to step S22.

In step S19, when it is determined that the amount of weight increase of the shopping baskets 16 and 17 is within the range of the fluctuation range of the amount of weight increase set in step S18, the process proceeds to step S20 described above, and the fraud judgment unit 38 determines that the fraud is not performed.

On the other hand, in step S19, if it is not determined that the amount of weight increase of the shopping baskets 16 and 17 is within the range of the fluctuation range of the amount of weight increase set in step S18, the fraud judgment unit 38 determines that the fraud is being performed. Then, the notification unit 39 notifies the display 21 that an item different from the registered item is accommodated in the shopping baskets 16 and 17 and that the item is to be rescanned (step S22). Thereafter, the shopping cart 10 ends the processing. In practice, after step S22, the shopping cart 10 repeats the process of FIG. 6 until the shopping cart 10 receives a re-scan from the customer and completes registration of all items.

As described above, the shopping cart 10 (item registration device for a shopping cart) of the first embodiment comprises: an item code acquisition unit 32 (identification information acquisition unit) for acquiring an item code (identification information) of an item the customer wishes to purchase; an item registration unit 33 for registering the item whose item code was acquired; a basket weight measurement unit 35 (weight measurement unit) for measuring the weight of shopping baskets 16 and 17 (containers) that hold items whose item codes have been acquired; a posture detection unit 36 that detects whether the shopping cart 10 is in a moving state or has tilted from a horizontal state; a weight fluctuation range setting unit 37 that sets a fluctuation range for the amount of weight increase in shopping baskets 16 and 17 corresponding to items with the item code acquired by the item code acquisition unit 32, provided that the posture detection unit 36 detects that the shopping cart 10 is in the moving state or tilted state when the basket weight measurement unit 35 determines that the weight of shopping baskets 16 and 17 has increased; a fraud judgment unit 38 that determines fraud has occurred when the amount of weight increase measured by the basket weight measurement unit 35 for shopping baskets 16 and 17 falls outside the fluctuation range set by the weight fluctuation range setting unit 37; and a notification unit 39 that notifies when the fraud judgment unit 38 determines fraud has occurred. Therefore, even when items are placed into the shopping baskets 16 and 17 while the shopping cart 10 is moving or tilted, it is possible to reliably determine whether the items placed in the shopping baskets 16 and 17 are scanned items. Therefore, even if an item is stored when the shopping cart 10 is moving or inclined, it is possible to reliably determine whether the item stored in the shopping baskets 16 and 17 is the scanned item.

### Second Embodiment

Next, a shopping cart 90 according to a second embodiment will be described. The hardware structure of the shopping cart 90 is the same as that of the shopping cart 10 (see FIGS. 1 and 2).

The shopping cart 90 of the second embodiment does not perform the fraud detection when an item is placed during movement or in an inclined state, but performs the fraud detection related to the item placed up to that point and notification when the shopping cart 90 is in a stationary and horizontal state.

### Functional Configuration of Shopping Cart

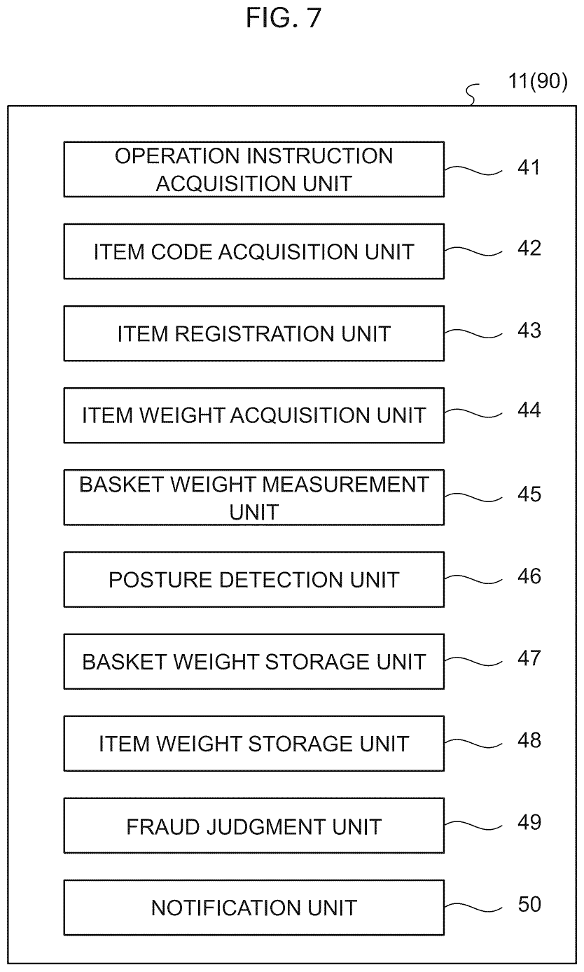

A functional configuration of the shopping cart 90 according to the second embodiment will be described with reference to FIG. 7. FIG. 7 is a functional block diagram illustrating an example of a functional configuration of a shopping cart according to the second embodiment.

The control unit 11 of the shopping cart 90 loads and executes the control program 121 in the RAM 113, thereby implementing an operation instruction acquisition unit 41, an item code acquisition unit 42, an item registration unit 43, an item weight acquisition unit 44, a basket weight measurement unit 45, a posture detection unit 46, a basket weight storage unit 47, an item weight storage unit 48, a fraud judgment unit 49, and a notification unit 50 illustrated in FIG. 7 as functional units. Note that some or all of these functional parts may be implemented by dedicated hardware.

The operation instruction acquisition unit 41 has the same function as the operation instruction acquisition unit 31 described in the first embodiment.

The item code acquisition unit 42 has the same function as the item code acquisition unit 32 described in the first embodiment.

The item registration unit 43 has the same function as the item registration unit 33 described in the first embodiment.

The item weight acquisition unit 44 has the same function as the item weight acquisition unit 34 described in the first embodiment.

The basket weight measurement unit 45 has the same function as the basket weight measurement unit 35 described in the first embodiment.

The posture detection unit 46 has the same function as the posture detection unit 36 described in the first embodiment.

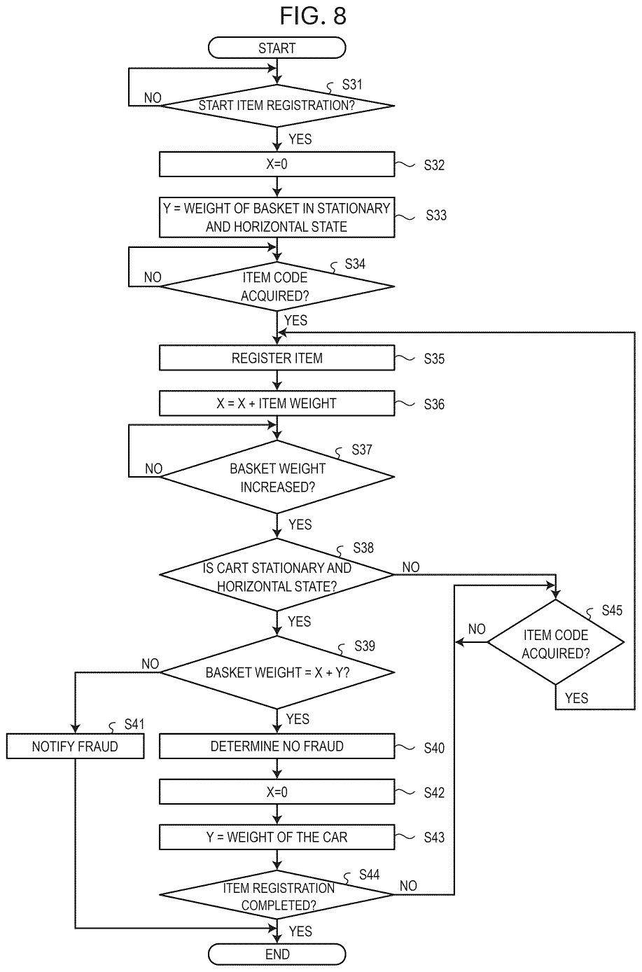

The basket weight storage unit 47 stores the latest basket weight Y (see FIG. 8) of the shopping baskets 16 and 17 in a state where the item is accommodated.

The item weight storage unit 48 cumulatively stores the total weight X (see FIG. 8) of the items based on the weight master 123, which is registered after the fraud judgment unit 49 determines that fraud has not been performed.

The fraud judgment unit 49 does not perform the fraud judgment even when the posture detection unit 46 detects that the shopping cart 90 is in the moving state or the inclined state and the basket weight measurement unit 45 determines that the weight of the shopping baskets 16 and 17 has increased, and determines that the fraud has been performed when the posture detection unit 46 detects that the shopping cart 90 is in the stationary state and the horizontal state and the basket weight Y of the shopping baskets 16 and 17 at that time is not equal to the sum of the basket weight Y of the shopping baskets 16 and 17 when it is determined that there is no fraud in the previous fraud judgment and the total weight X of the items registered after the previous fraud judgment.

The notification unit 50 has the same function as the notification unit 39 described in the first embodiment.

### Flow of Processing Performed by Shopping Cart of Second Embodiment

A flow of processing performed by the shopping cart 90 according to the second embodiment will be described with reference to FIG. 8. FIG. 8 is a flowchart of processing performed by the shopping cart 10 according to the second embodiment.

The operation instruction acquisition unit 41 determines whether the customer has started item registration (step S31). When it is determined that the customer has started item registration (step S31: Yes), the process proceeds to step S32. On the other hand, when it is not determined that the customer has started item registration (step S31: No), the determination of step S31 is repeated.

When it is determined in step S31 that the customer has started item registration, the item weight storage unit 48 sets the total weight X of the items to 0 (step S32).

The basket weight storage unit 47 stores the basket weight Y of the shopping baskets 16 and 17 when the shopping cart 90 is in the stationary and horizontal state (step S33). The basket weight Y stored in the step S33 is the weight of the shopping baskets 16 and 17 in a state where no items are accommodated.

The item code acquisition unit 42 determines whether the item code has been acquired (step S34). When it is determined that the item code has been acquired (step S34: Yes), the process proceeds to step S35. On the other hand, when it is not determined that the item code has been acquired (step S34: No), the determination of step S34 is repeated.

When it is determined in step S34 that the item code has been acquired, the item registration unit 43 registers the item having the item code acquired by the item code acquisition unit 42 in the item registration file 124 (step S35).

The item weight storage unit 48 reads the weight of the item having the item code acquired by the item code acquisition unit 42 from the weight master 123, adds the weight to the total weight X of the items, and stores the total weight X of the items (step S36).

The basket weight measurement unit 45 determines whether the weight of the shopping baskets 16 and 17 has increased (step S37). When it is determined that the weight of the shopping baskets 16 and 17 has increased (step S37: Yes), the process proceeds to step S38. On the other hand, when it is not determined that the weight of the shopping baskets 16 and 17 has increased (step S37: No), the determination of step S37 is repeated.

When it is determined in step S37 that the weight of the shopping baskets 16 and 17 has increased, the posture detection unit 46 determines whether the shopping cart 90 is in the stationary state and the horizontal state (step S38). If it is determined that the shopping cart 90 is in the stationary state and the horizontal state (step S38: Yes), the process proceeds to step S39. On the other hand, if it is not determined that the shopping cart 90 is in the stationary state and the horizontal state (step S38: No), the process proceeds to step S45.

When it is determined in step S38 that the shopping cart 90 is in the stationary state and the horizontal state, the fraud judgment unit 49 determines whether the basket weight of the shopping baskets 16 and 17 at that time is equal to the sum of the total weight X of the items stored in the item weight storage unit 48 and the basket weight Y stored in the basket weight storage unit 47 (step S39). When it is determined that the basket weight of the shopping baskets 16 and 17 is equal to the sum of the total weight X of the items and basket weight Y (step S39: Yes), the process proceeds to step S40. On the other hand, when it is not determined that the basket weight of the shopping baskets 16 and 17 is equal to the sum of the total weight X of the items and the basket weight Y (step S39: No), the process proceeds to step S41.

When it is determined in step S39 that the basket weight of the shopping baskets 16 and 17 is equal to the sum of the total weight X of the items and basket weight Y, the fraud judgment unit 49 determines that the fraud is not being performed (step S40).

The item weight storage unit 48 sets the total weight X of the items to 0 (step S42).

The basket weight storage unit 47 stores the basket weight Y of the shopping baskets 16 and 17 (step S43). Note that the basket weight Y stored in step S43 is the weight of the shopping baskets 16 and 17 in a state where items are accommodated.

The operation instruction acquisition unit 41 determines whether registration of all items is completed (step S44). When it is determined that the registration of all the items is completed (step S44: Yes), the shopping cart 90 ends the process. On the other hand, when it is not determined that the registration of all the items is completed (step S44: No), the process proceeds to step S45.

When it is not determined in step S44 that registration of all items is completed, the item code acquisition unit 42 determines whether an item code has been acquired (step S45). When it is determined that the item code has been acquired (step S45: Yes), the process returns to step S35 and the above-described process is repeated. On the other hand, when it is not determined that the item code has been acquired (step S45: No), the determination of step S45 is repeated.

The description returns to step S39. If it is not determined in step S39 that the basket weight of the shopping baskets 16 and 17 is equal to the sum of the total weight X of the items and basket weight Y, the fraud judgment unit 49 determines that a fraud is being held. Then, the notification unit 50 notifies the display 21 that an item different from the registered item is accommodated in the shopping baskets 16 and 17 and that the item is to be rescanned (step S41). The shopping cart 90 then ends the process. In the present embodiment, it is not possible to specify which item is determined as a fraud. Therefore, the customer operates a store clerk call button (not illustrated) displayed on the display 21 to call the store clerk. The clerk confirms the registration state of the item and the contents of the shopping baskets 16 and 17, and cancels the registration of the item associated with the registration error. Then, the customer is prompted to scan the correct item.

As described above, the shopping cart 90 (item registration device for a shopping cart) of the second embodiment includes the item code acquisition unit 42 (identification information acquisition unit) that acquires the item code (identification information) of the item that the customer desires to purchase, the item registration unit 43 that registers the item whose item code has been acquired, the basket weight measurement unit 45 (weight measurement unit) that measures the weight of the shopping baskets 16 and 17 (containers) that contain the item whose item code has been acquired, the posture detection unit 46 that detects whether the shopping cart 90 is in the moving state or in the state of being inclined from the horizontal state, the fraud judgment unit 49 that, when the posture detection unit 46 detects that the shopping cart 90 is in a moving state or a tilted state, does not perform a fraud judgment even when the basket weight measurement unit 45 determines that the weight of the shopping baskets 16 and 17 has increased, and when the posture detection unit 46 detects that the shopping cart 90 is in a stationary state and a horizontal state, determines that a fraud has been performed when the weight of the shopping baskets 16 and 17 at that time is not equal to the sum of the basket weight Y of the shopping baskets 16 and 17 when it is determined that there is no fraud in the last fraud judgment and the total weight X of the items registered after the last fraud judgment, and the notification unit 50 that notifies that the fraud judgment has determined that the fraud has been performed when the fraud judgment determines that the fraud has been performed. Therefore, when the item is placed while the shopping cart 90 is moving or inclined, it is possible to reliably determine whether the item placed in the shopping baskets 16 and 17 is a scanned item after waiting for the shopping cart 90 to be in the stationary state and the horizontal state.

### Third Embodiment

Next, a shopping cart 91 according to a third embodiment will be described. The hardware structure of the shopping cart 91 is the same as that of the shopping cart 10 (see FIGS. 1 and 2).

The shopping cart 91 of the third embodiment alerts the customer when an item is placed while moving or in a tilted state, and performs a fraud judgment when the shopping cart 91 is in a stationary and horizontal state.

### Functional Configuration of Shopping Cart

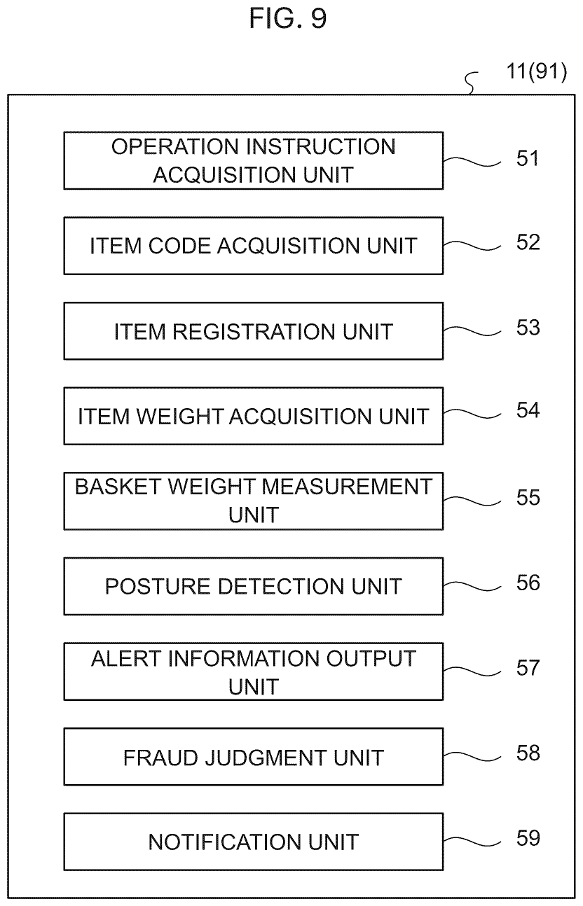

A functional configuration of the shopping cart 91 according to the third embodiment will be described with reference to FIG. 9. FIG. 9 is a functional block diagram of the shopping cart 91 according to the third embodiment.

The control unit 11 of the shopping cart 91 loads the control program 121 in the RAM 113 and executes the control program 121, thereby implementing an operation instruction acquisition unit 51, an item code acquisition unit 52, an item registration unit 53, an item weight acquisition unit 54, a basket weight measurement unit 55, a posture detection unit 56, an alert information output unit 57, a fraud judgment unit 58, and a notification unit 59 illustrated in FIG. 9 as functional units. Note that some or all of these functional parts may be implemented by dedicated hardware.

The operation instruction acquisition unit 51 has the same function as the operation instruction acquisition unit 31 described in the first embodiment.

The item code acquisition unit 52 has the same function as the item code acquisition unit 32 described in the first embodiment.

The item registration unit 53 has the same function as the item registration unit 33 described in the first embodiment.

The item weight acquisition unit 54 has the same function as the item weight acquisition unit 34 described in the first embodiment.

The basket weight measurement unit 55 has the same function as the basket weight measurement unit 35 described in the first embodiment.

The posture detection unit 56 has the same function as the posture detection unit 36 described in the first embodiment.

When the basket weight measurement unit 55 determines that the weight of the shopping baskets 16 and 17 has increased, the alert information output unit 57 outputs alert information to alert the customer to place the item when the shopping cart 91 is in the horizontal state with the shopping cart 91 being stationary, on condition that the posture detection unit 56 detects that the shopping cart 91 is in the moving state or the tilted state. The alert information output unit 57 displays the alert information on the display 21, for example.

The fraud judgment unit 58 judges that a fraud has been performed when the amount of weight increase of the shopping baskets 16 and 17 measured by the basket weight measurement unit 55 is not equal to the weight of the item having the item code acquired by the item code acquisition unit 52, on condition that the posture detection unit 56 has detected that the shopping cart 91 is in the stationary state and the horizontal state.

The notification unit 59 has the same function as the notification unit 39 described in the first embodiment.

### Flow of Processing Performed by Shopping Cart of Third Embodiment

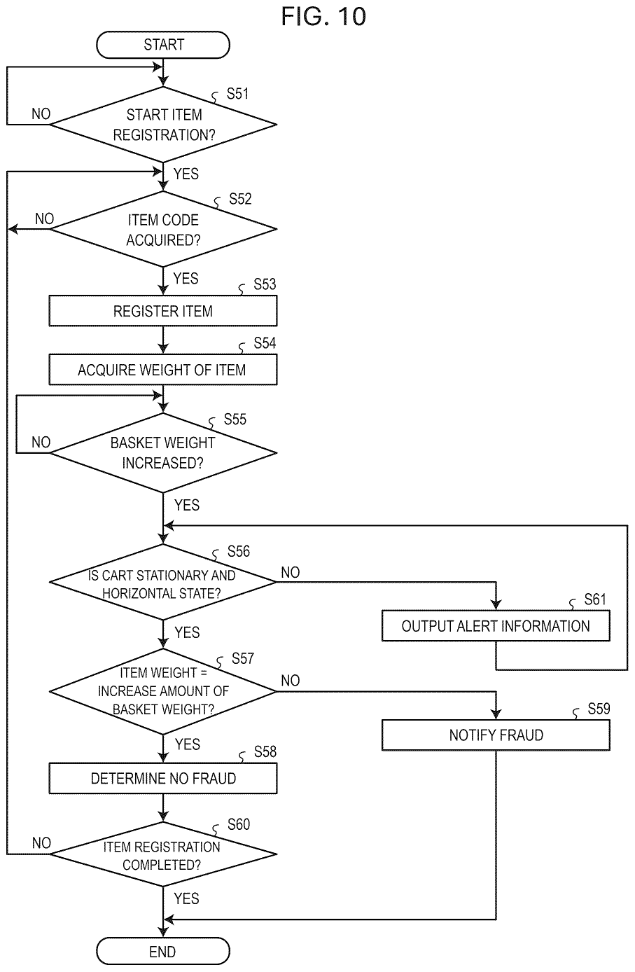

A flow of processing performed by the shopping cart 91 according to the third embodiment will be described with reference to FIG. 10. FIG. 10 is a flowchart of processing performed by the shopping cart 91 according to the third embodiment.

The operation instruction acquisition unit 51 determines whether the customer has started item registration (step S51). When it is determined that the customer has started item registration (step S51: Yes), the process proceeds to step S52. On the other hand, when it is not determined that the customer has started item registration (step S51: No), the determination of step S51 is repeated.

When it is determined in step S51 that the customer has started item registration, the item code acquisition unit 52 determines whether an item code has been acquired (step S52). When it is determined that the item code has been acquired (step S52: Yes), the process proceeds to step S53. On the other hand, when it is not determined that the item code has been acquired (step S52: No), the determination of step S52 is repeated.

When it is determined in step S52 that the item code has been acquired, the item registration unit 53 registers the item having the item code acquired by the item code acquisition unit 52 in the item registration file 124 (step S53).

The item weight acquisition unit 54 acquires the weight of the item registered by the item registration unit 53 from the weight master 123 (step S54).

The basket weight measurement unit 55 determines whether the weight of the shopping baskets 16 and 17 has increased (step S55). When it is determined that the weight of the shopping baskets 16 and 17 has increased (step S55: Yes), the process proceeds to step S56. On the other hand, when it is not determined that the weight of the shopping baskets 16 and 17 has increased (step S55: No), the determination of step S55 is repeated.

When it is determined in step S55 that the weight of the shopping baskets 16 and 17 has increased, the posture detection unit 56 determines whether the shopping cart 91 is in the stationary state and the horizontal state (step S56). When it is determined that the shopping cart 91 is in the stationary state and the horizontal state (step S56: Yes), the process proceeds to step S57. On the other hand, when it is not determined that the shopping cart 91 is in the stationary state and the horizontal state (step S56: No), the process proceeds to step S61.

When it is determined in step S56 that the shopping cart 91 is in the stationary state and the horizontal state, the fraud judgment unit 58 determines whether the weight of the item acquired in step S54 is equal to the amount of weight increase of the shopping baskets 16 and 17 measured in step S55 (step S57). When it is determined that the weight of the item acquired in step S54 is equal to the amount of weight increase of the shopping baskets 16 and 17 measured in step S55 (step S57: Yes), the process proceeds to step S58. On the other hand, when it is not determined that the weight of the item acquired in step S54 is equal to the amount of weight increase of the shopping baskets 16 and 17 measured in step S55 (step S57: No), the fraud judgment unit 38 determines that the fraud is being performed, and proceeds to step S59.

When it is determined in step S57 that the weight of the item acquired in step S54 is equal to the amount of weight increase of the shopping baskets 16 and 17 measured in step S55, the fraud judgment unit 58 determines that the fraud is not performed (step S58). Thereafter, the process proceeds to step S60.

On the other hand, in step S57, when it is not determined that the weight of the item acquired in step S54 is equal to the amount of weight increase of the shopping baskets 16 and 17 measured in step S55, the notification unit 59 notifies the display 21 that an item different from the registered item is accommodated in the shopping baskets 16 and 17 and that the item is to be rescanned (step S59). Thereafter, the shopping cart 91 ends the processing. In practice, after step S59, the shopping cart 91 receives a re-scan from the customer and repeats the process of FIG. 10 until the registration of all items is completed.

Following step S58, the operation instruction acquisition unit 51 determines whether registration of all items is completed (step S60). When it is determined that the registration of all the items is completed (step S60: Yes), the shopping cart 91 ends the process. On the other hand, when it is not determined that the registration of all the items is completed (step S60: No), the process returns to step S52.

The description returns to step S56. If it is not determined in step S56 that the shopping cart 91 is in the stationary state and the horizontal state, the alert information output unit 57 notifies the display 21 of alert information prompting to place the item when the shopping cart 91 is stationary and in the horizontal state (step S61). Thereafter, the determination of step S56 is repeated.

As described above, the shopping cart 91 (item registration device for shopping cart) of the third embodiment includes the item code acquisition unit 52 (identification information acquisition unit) that acquires the item code (identification information) of the item that the customer desires to purchase, the item registration unit 53 that registers the item whose item code has been acquired, the posture detection unit 56 that detects whether the shopping cart 91 is in the moving state or the state in which the shopping cart 91 is tilted from the horizontal state, the basket weight measurement unit 55 (weight measurement unit) that measures the weight of the shopping baskets 16 and 17 that accommodate the item whose item code has been acquired, the fraud judgment unit 58 that judges that the fraud has been performed when the amount of weight increase of the shopping baskets 16 and 17 measured by the basket weight measurement unit 55 is not equal to the weight of the item having the item code acquired by the item code acquisition unit 52, and the notification unit 59 that notifies that the fraud judgment unit 58 has judged that the fraud has been performed. Therefore, when the item is placed while the shopping cart 91 is moving or inclined, the customer is alerted to place the item while the shopping cart 91 is stationary and in the horizontal state, and the determination of whether the item placed in the shopping baskets 16 and 17 is a scanned item is performed after the shopping cart 91 is in the stationary state and is in the horizontal state, so that the customer can be alerted and the determination of whether the placed item is a scanned item can be reliably performed.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A shopping cart comprising:
one or more frames on which one or more containers for storing one or more items can be placed;
a weight sensor configured to measure a weight of the one or more containers placed on the one or more frames;
a scanner configured to scan a symbol attached to an item and read item information from the symbol;
a display attached to the one or more frames and configured to display a screen showing information regarding an item registered for purchase;
an acceleration sensor;
a memory that stores a program; and
a processor configured to execute the program to:
acquire identification information of an item scanned by the scanner,
register the scanned item for purchase using the identification information,
upon detection of weight increase of the one or more containers by the weight sensor, determine whether the shopping cart is in a moving state or in a state tilted from a horizontal state based on an output from the acceleration sensor,
in response to determining that the shopping cart is in the moving state or in the state tilted from the horizontal state, set a fluctuation range for an amount of weight increase of the one or more containers corresponding to the scanned item,
determine that an irregularity has occurred when the amount of weight increase of the one or more containers measured by the weight sensor is outside the set fluctuation range, and
after determining that the irregularity has occurred, control the display to display alert information indicating that the irregularity has occurred.

2. The shopping cart according to claim 1, wherein
the processor is further configured to execute the program to determine that an irregularity has not occurred when the amount of weight increase of the one or more containers measured by the weight sensor is within the set fluctuation range.

3. The shopping cart according to claim 1, wherein
the processor is further configured to execute the program to:
in response to determining that the shopping cart is neither in the moving state nor in the state tilted from the horizontal state, determine whether the amount of weight increase of the one or more containers measured by the weight sensor corresponds to a predetermined weight of the scanned item, and
determine that an irregularity has occurred when the amount of weight increase of the one or more containers measured by the weight sensor does not correspond to a predetermined weight of the scanned item.

4. The shopping cart according to claim 1, wherein
the processor is further configured to execute the program to determine that an irregularity has not occurred when the amount of weight increase of the one or more containers measured by the weight sensor corresponds to a predetermined weight of the scanned item.

5. The shopping cart according to claim 1, wherein
the alert information prompts a customer to rescan the item.

6. The shopping cart according to claim 1, wherein
the one or more frames include:
a first frame capable of holding a first container,
a second frame disposed below the first frame and capable of holding a second container, and
a pair of third frames extending downward from the first frame to hold the second frame, and
the weight sensor is disposed below the first frame to weigh the first and second containers.

7. The shopping cart according to claim 6, further comprising:
a fourth frame to which a handle, the scanner, and the display are attached.

8. A method performed by a shopping cart that includes:
one or more frames on which one or more containers for storing one or more items can be placed,
a weight sensor configured to measure a weight of the one or more containers placed on the one or more frames,
a scanner configured to scan a symbol attached to an item and read item information from the symbol,
a display attached to the one or more frames and configured to display a screen showing information regarding an item registered for purchase, and
an acceleration sensor, the method comprising:
acquiring identification information of an item scanned by the scanner;
registering the scanned item for purchase using the identification information;
upon detection of weight increase of the one or more containers by the weight sensor, determining whether the shopping cart is in a moving state or in a state tilted from a horizontal state based on an output from the acceleration sensor;
in response to determining that the shopping cart is in the moving state or in the state tilted from the horizontal state, setting a fluctuation range for an amount of weight increase of the one or more containers corresponding to the scanned item;
determining that an irregularity has occurred when the amount of weight increase of the one or more containers measured by the weight sensor is outside the set fluctuation range; and
after determining that the irregularity has occurred, controlling the display to display alert information indicating that the irregularity has occurred.

9. The method according to claim 8, further comprising:
determining that an irregularity has not occurred when the amount of weight increase of the one or more containers measured by the weight sensor is within the set fluctuation range.

10. The method according to claim 8, further comprising:
in response to determining that the shopping cart is neither in the moving state nor in the state tilted from the horizontal state, determining whether the amount of weight increase of the one or more containers measured by the weight sensor corresponds to a predetermined weight of the scanned item; and
determining that an irregularity has occurred when the amount of weight increase of the one or more containers measured by the weight sensor does not correspond to a predetermined weight of the scanned item.

11. The method according to claim 8, further comprising:
determining that an irregularity has not occurred when the amount of weight increase of the one or more containers measured by the weight sensor corresponds to a predetermined weight of the scanned item.

12. The method according to claim 8, wherein
the alert information prompts a customer to rescan the item.

13. The method according to claim 8, wherein
the amount of weight increase of the one or more containers includes an amount of weight increase of a first container held on a first frame and an amount of weight increase of a second container held on a second frame disposed below the first frame and connected to the first frame via a pair of third frames.

14. An item registration device attachable to a shopping cart that includes a weight sensor configured to measure a weight of one or more containers on the shopping cart and a scanner configured to scan a symbol attached to an item and read item information from the symbol, the item registration device comprising:
a display configured to display a screen showing information regarding an item registered for purchase;
an acceleration sensor;
a memory that stores a program; and
a processor configured to execute the program to:
acquire identification information of an item scanned by the scanner,
register the scanned item for purchase using the identification information,
upon detection of weight increase of the one or more containers by the weight sensor, determine whether the shopping cart is in a moving state or in a state tilted from a horizontal state based on an output from the acceleration sensor,
in response to determining that the shopping cart is in the moving state or in the state tilted from the horizontal state, set a fluctuation range for an amount of weight increase of the one or more containers corresponding to the scanned item,
determine that an irregularity has occurred when the amount of weight increase of the one or more containers measured by the weight sensor is outside the set fluctuation range, and
after determining that the irregularity has occurred, control the display to display alert information indicating that the irregularity has occurred.

15. The item registration device according to claim 14, wherein
the processor is further configured to execute the program to determine that an irregularity has not occurred when the amount of weight increase of the one or more containers measured by the weight sensor is within the set fluctuation range.

16. The item registration device according to claim 14, wherein
the processor is further configured to execute the program to:
in response to determining that the shopping cart is neither in the moving state nor in the state tilted from the horizontal state, determine whether the amount of weight increase of the one or more containers measured by the weight sensor corresponds to a predetermined weight of the scanned item, and
determine that an irregularity has occurred when the amount of weight increase of the one or more containers measured by the weight sensor does not correspond to a predetermined weight of the scanned item.

17. The item registration device according to claim 14, wherein
the processor is further configured to execute the program to determine that an irregularity has not occurred when the amount of weight increase of the one or more containers measured by the weight sensor corresponds to a predetermined weight of the scanned item.

18. The item registration device according to claim 14, wherein
the alert information prompts a customer to rescan the item.

19. The item registration device according to claim 14, wherein
the amount of weight increase of the one or more containers includes an amount of weight increase of a first container held on a first frame and an amount of weight increase of a second container held on a second frame disposed below the first frame and connected to the first frame via a pair of third frames.

20. The item registration device according to claim 19, wherein
the display is attached to a fourth frame of the shopping cart connected to the first frame and to which a handle of the shopping cart is attached.
